(19) United States
(12) Patent Application Publication
(10) Pub. No.: US 2026/0098759 A1
(43) Pub. Date: Apr. 9, 2026

(54) GAS ABSORPTION SPECTROSCOPY APPARATUS

(71) Applicant: SHIMADZU CORPORATION, Kyoto-shi (JP)

(72) Inventors: Kazune MANO, Kyoto-shi (JP); Tetsuo FURUMIYA, Kyoto-shi (JP); Koji TOJO, Kyoto-shi (JP)

(21) Appl. No.: 19/352,180

(22) Filed: Oct. 7, 2025

(30) Foreign Application Priority Data
Oct. 9, 2024 (JP) 2024-176924

(51) Int. Cl. G01J 3/10; G01J 3/433

(52) U.S. Cl. CPC G01J 3/10; G01J 3/4338; G01J 2003/102; G01J 2003/4332

(57) ABSTRACT

A gas absorption spectroscopy apparatus includes a first light source, a first resonator, an optical modulator disposed in an optical path between the first light source and the first resonator, and a frequency stabilization circuit disposed so that a negative feedback circuit is configured between the first light source and the optical modulator, wherein the frequency stabilization circuit includes a second light source and a light stabilization unit.

### TECHNICAL FIELD

The present disclosure relates to a gas absorption spectroscopy apparatus for determining the concentration of a target component in a gas using Cavity Ring-Down absorption Spectroscopy (CRDS).

### BACKGROUND ART

Cavity Ring-Down Spectroscopy (CRDS) is known as a type of gas absorption spectroscopy. CRDS is a spectroscopic technique that uses a resonator (cavity) to extend the effective optical path length, thereby enabling high-sensitivity determination of the concentration of a target component contained in the gas within the resonator.

In CRDS, laser light is input from a light source to a resonator. The laser light input to the resonator is accumulated in the resonator. After a sufficient amount of laser light has been accumulated in the resonator, the input of the laser light to the resonator is blocked. Subsequently, the decay of the light leaking from the resonator is measured. The gas absorption spectroscopy apparatus acquires the output signal of a photodetector as a "ring-down signal." The gas absorption spectroscopy apparatus measures the concentration of the target component contained in the gas within the resonator by calculating the decay time constant (ring-down time) of the light using the acquired ring-down signal.

Non-Patent Literature 1 discloses a gas absorption spectroscopy apparatus in which a feedback system operating based on the Pound-Drever-Hall (PDH) method is inserted into the optical path from the light source to the resonator. According to the gas absorption spectroscopy apparatus described in Non-Patent Literature 1, narrowing of the laser light linewidth can be achieved.

### PRIOR ART DOCUMENT

### NON-PATENT LITERATURE

[Non-Patent Literature 1] "Pound-Drever-Hall-locked, frequency-stabilized cavity ring-down spectrometer", A. Cygan; D. Lisak; P. Maslowski; K. Bielska; S. Wojtewicz; J. Domyslawska; R. S. Trawinski; R. Ciurylo; H. Abe; J. T. Hodges, Review of Scientific Instruments, Jun. 16, 2011

### SUMMARY OF THE INVENTION

### PROBLEM TO BE SOLVED BY THE INVENTION

In CRDS, it is necessary to block the incidence of light into the resonator to acquire the ring-down signal. For this reason, in a conventional gas absorption spectroscopy apparatus as described in Non-Patent Literature 1, there are times when the light returning to the feedback system is interrupted. Therefore, when the incidence of light into the resonator is resumed, the optimal wavelength of light for the resonator and the wavelength of the light incident on the resonator may be misaligned. As a result, a problem arises in that the gas absorption spectroscopy apparatus cannot achieve PDH lock after acquiring the ring-down signal, and thus cannot stabilize the frequency of the laser light.

The present invention has been made to solve such a problem, and its object is to stabilize the frequency of the laser light even when the incidence of light into the resonator is blocked to acquire a ring-down signal.

### MEANS FOR SOLVING THE PROBLEM

A gas absorption spectroscopy apparatus according to the present disclosure is a gas absorption spectroscopy apparatus for measuring a gas component, comprising a first light source that outputs first laser light used for measuring the gas component, a first resonator to which the first laser light is input, an optical modulator disposed in an optical path between the first light source and the first resonator, and a frequency stabilization circuit disposed so that a negative feedback circuit is configured between the first light source and the optical modulator, wherein the frequency stabilization circuit includes a second light source that outputs second laser light for stabilizing the first laser light, and a light stabilization unit that stabilizes the second laser light.

### EFFECTS OF THE INVENTION

According to the present disclosure, it is possible to stabilize the frequency of the laser light even when the incidence of light into the resonator is blocked to acquire a ring-down signal.

### BRIEF DESCRIPTION OF THE DRAWINGS

FIG. 1 is a diagram schematically showing the configuration of a gas absorption spectroscopy apparatus.

FIG. 2 is a conceptual diagram for explaining mode frequencies.

FIG. 3 is a diagram schematically showing a detailed configuration of a frequency stabilization circuit.

FIG. 4 is a diagram schematically showing the configuration of a frequency stabilization circuit according to Modification 1.

FIG. 5 is a diagram schematically showing the configuration of a frequency stabilization circuit according to Modification 2.

### DESCRIPTION OF EMBODIMENTS

Hereinafter, the present embodiment will be described in detail with reference to the drawings. In the following description, the same or corresponding parts in the drawings are denoted by the same reference numerals, and a description thereof will not be repeated.

### Configuration of Gas Absorption Spectroscopy Apparatus

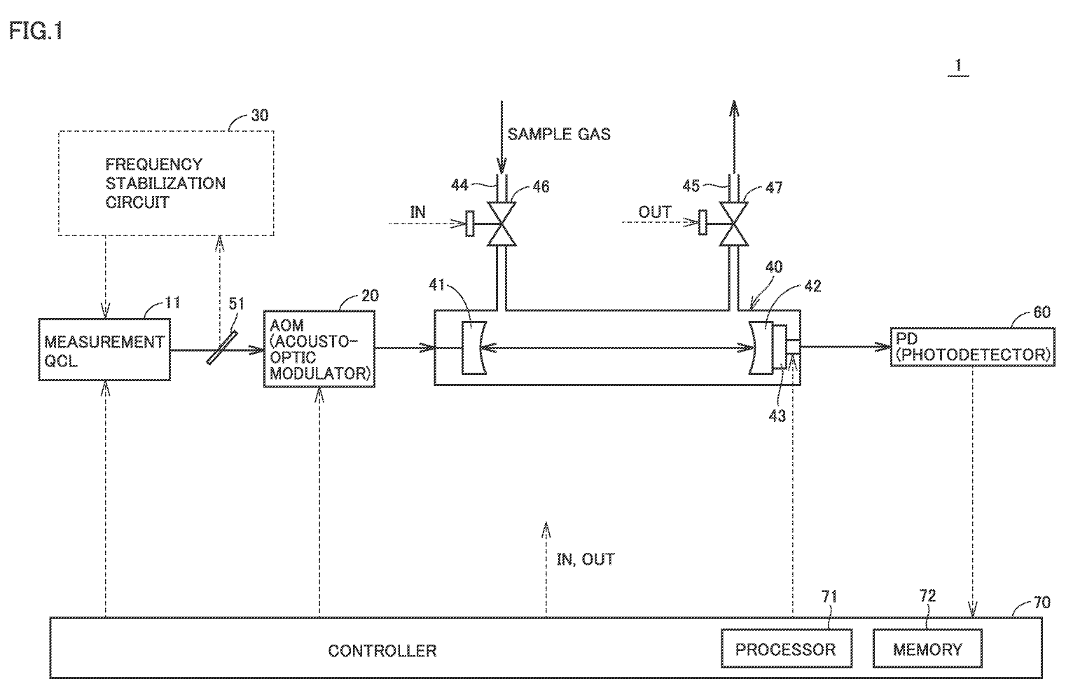

FIG. 1 is a diagram schematically showing the configuration of a gas absorption spectroscopy apparatus 1 according to the present embodiment. The gas absorption spectroscopy apparatus 1 includes a measurement QCL (Quantum Cascade Laser) 11, an AOM (Acousto-Optic Modulator) 20, a frequency stabilization circuit 30, a CRDS resonator 40, a photodetector (PD) 60, and a controller 70.

The measurement QCL 11 is an example of a first light source that outputs first laser light used for measuring a gas component. The measurement QCL 11 is configured to have a variable laser light oscillation frequency in accordance with a command from the controller 70. Specifically, the measurement QCL 11 is a distributed feedback quantum cascade laser (QCL).

The AOM 20 is provided in the optical path between the measurement QCL 11 and the CRDS resonator 40. The AOM 20 is an example of an optical modulator. The AOM 20 is an optical switch (switcher) that switches at high speed between outputting and blocking the laser light from the measurement QCL 11 to the CRDS resonator 40. The AOM 20 switches the input (incidence) of light to the CRDS resonator 40 between ON and OFF. The AOM 20 enters an ON state, in which it outputs the laser light from the measurement QCL 11 to the CRDS resonator 40, when an ON command for outputting light is applied from the controller 70. The AOM 20 enters an OFF state, in which it does not output the laser light from the measurement QCL 11 to the CRDS resonator 40, when an OFF command for blocking light is applied from the controller 70. The AOM 20 may switch the frequency in addition to switching the optical path when switching the light input between ON and OFF.

The CRDS resonator 40 is provided in the optical path between the AOM 20 and the photodetector 60. The CRDS resonator 40 is an example of a first resonator. The CRDS resonator 40 is configured to include a container (cell) capable of sealing a sample gas, and has an inlet pipe 44 for introducing the sample gas into the interior before the start of measurement, and an outlet pipe 45 for discharging the sample gas to the outside after the end of measurement. The inlet pipe 44 is provided with an inlet valve 46. The outlet pipe 45 is provided with an outlet valve 47. The controller 70 controls the opening and closing of the inlet valve 46 and the outlet valve 47.

Inside the CRDS resonator 40, a pair of mirrors 41 and 42 is provided. The mirrors 41 and 42 are arranged opposite each other such that light is reflected between them within the CRDS resonator 40. At least one of the mirrors 41 and 42 is a concave mirror to facilitate satisfying the stability condition of the CRDS resonator 40. Further, mirrors with high reflectivity (e.g., about 99.9%) are used for the mirrors 41 and 42 so that the light leaking to the outside of the CRDS resonator 40 is extremely weak. The number of mirrors arranged inside the CRDS resonator 40 is not limited to two and may be three or more. That is, it may be a resonator in which mirrors are arranged so that light is reflected between them, or a resonator in which mirrors are arranged in a ring shape so that light is reflected in one direction.

A piezoelectric element 43 is disposed on the mirror 42. The piezoelectric element 43 displaces the mirror 42 in the optical axis direction by driving the mirror 42 constituting the CRDS resonator 40 in accordance with a command from the controller 70. This changes the resonator length of the CRDS resonator 40. Note that a piezoelectric element may be disposed on the mirror 41 instead of the mirror 42, or piezoelectric elements may be disposed on both the mirror 41 and the mirror 42.

The photodetector 60 is, for example, a photodiode. The photodetector 60 detects the weak light extracted from the mirror 42 of the CRDS resonator 40 as the output light of the CRDS resonator 40 and outputs a detection signal to the controller 70. For the photodetector 60, for example, a liquid nitrogen-cooled InSb (indium antimonide) detector can be adopted.

A beam splitter 51 is provided in the optical path between the measurement QCL 11 and the AOM 20. The beam splitter 51 splits the laser light output from the measurement QCL 11 into an optical path toward the AOM 20 and an optical path toward the frequency stabilization circuit 30.

The controller 70 includes a processor 71 such as a CPU (Central Processing Unit) or an FPGA (Field-Programmable Gate Array), a memory 72 such as a ROM (Read Only Memory) and a RAM (Random Access Memory), and an input/output port (not shown).

The controller 70 controls each device constituting the gas absorption spectroscopy apparatus 1. Specifically, the controller 70 outputs a command for scanning the oscillation frequency of the laser light to a laser driver 12, and outputs the above-mentioned ON signal or OFF signal to the AOM 20. The controller 70 outputs a command for introducing the sample gas into the CRDS resonator 40 to the inlet valve 46, and outputs a command for discharging the sample gas from the CRDS resonator 40 to the outside to the outlet valve 47.

The controller 70 applies a voltage for displacing the mirror 42 to the piezoelectric element 43. The controller 70 executes various data processing. The various data processing includes processing for calculating the concentration (absolute concentration) of the target component contained in the sample gas based on the detection signal from the photodetector 60.

The controller 70 may be configured by being divided into two or more units for each function. For example, the controller 70 may be divided into a unit that controls each device and a unit that executes various data processing.

### Measurement Principle by Cavity Ring-Down Spectroscopy (CRDS)

The measurement principle by cavity ring-down absorption spectroscopy in the gas absorption spectroscopy apparatus 1 will be described. In general, resonance occurs in a resonator when the frequency of the light irradiated onto the resonator is a specific frequency. Hereinafter, the frequency of the laser light input to the CRDS resonator 40 is referred to as "laser frequency," and the frequency of light at which resonance can occur by the CRDS resonator 40 is referred to as "mode frequency."

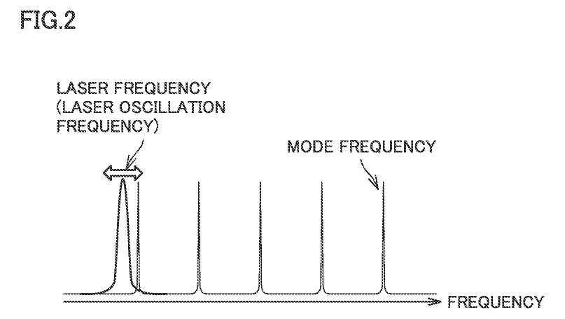

FIG. 2 is a conceptual diagram for explaining mode frequencies. As shown in FIG. 2, a plurality of mode frequencies exists at predetermined frequency intervals. Hereinafter, the interval between two adjacent mode frequencies among the plurality of mode frequencies is referred to as the "Free Spectral Range" (FSR).

If the laser frequency does not match any of the mode frequencies, the power of the light is not stored in the CRDS resonator 40. On the other hand, if the laser frequency matches any of the mode frequencies, the power of the light is stored in the CRDS resonator 40.

The controller 70 determines whether the power of the laser light has been sufficiently stored in the CRDS resonator 40 based on the output signal of the photodetector 60. When the controller 70 determines that the power of the laser light has been sufficiently stored in the CRDS resonator 40, it outputs an OFF signal to the AOM 20. As a result, the light input to the CRDS resonator 40 is blocked.

Then, the light stored in the CRDS resonator 40 travels back and forth between the mirror 41 and the mirror 42 many times (typically thousands to tens of thousands of times). This light gradually decays as it travels back and forth between the mirrors 41 and 42 due to losses from reflection leakage of the mirrors 41 and 42, and absorption by the target component in the sample gas. Therefore, the output light of the CRDS resonator 40 leaking from the mirror 42 gradually decays. In CRDS, by using the CRDS resonator 40 to lengthen the distance that the light passes through the sample gas (effective optical path length), the light absorption can be detected even if the light absorption by the target component is extremely small.

The controller 70 acquires the signal detected by the photodetector 60 while the light input to the CRDS resonator 40 is blocked as a "ring-down signal." The controller 70 calculates the decay time constant of the acquired ring-down signal as the "ring-down time." The controller 70 calculates the concentration of the target component contained in the sample gas from the calculated ring-down time.

### Configuration of Frequency Stabilization Circuit

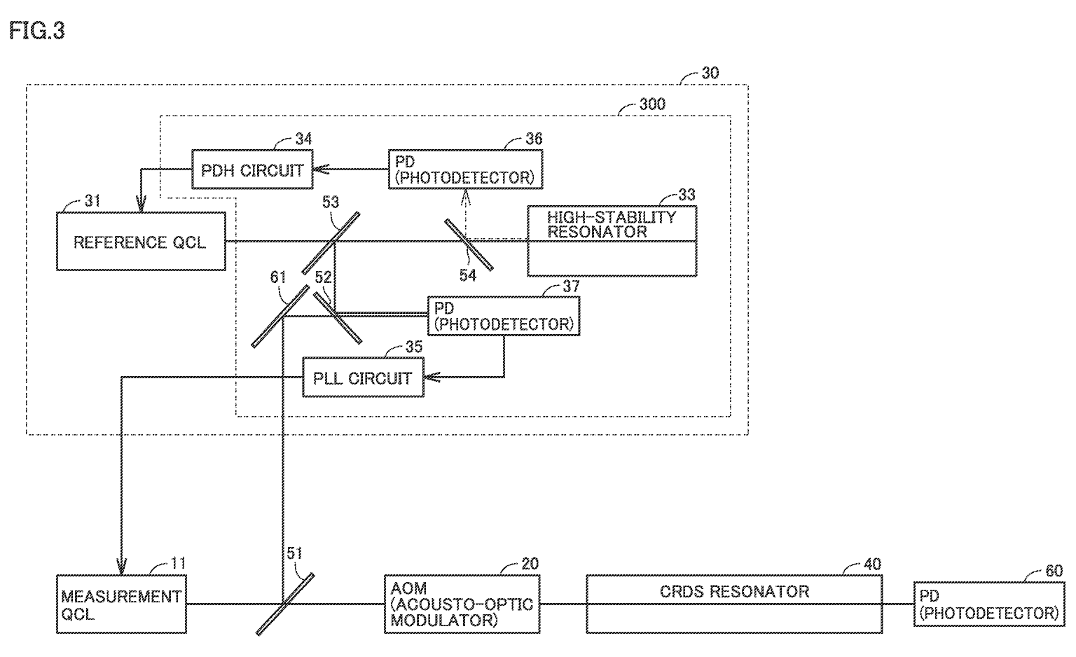

FIG. 3 is a diagram schematically showing a detailed configuration of the frequency stabilization circuit 30. As shown in FIG. 3, the frequency stabilization circuit 30 includes a reference QCL 31, a high-stability resonator 33, a PDH circuit 34, a PLL (Phase Locked Loop) circuit 35, photodetectors (PD) 36 and 37, beam splitters 52 to 54, and a mirror 61.

The high-stability resonator 33, the PDH circuit 34, the PLL circuit 35, the photodetectors 36, 37, the beam splitters 52-54, and the mirror 61 constitute a light stabilization unit 300.

The frequency stabilization circuit 30 stabilizes the frequency of the laser light from the reference QCL 31 with respect to the high-stability resonator 33. The high-stability resonator 33, the PDH circuit 34, and the photodetector 36 operate according to the Pound-Drever-Hall (PDH) method. The PDH circuit 34 performs PDH control to stabilize the frequency of the laser light from the reference QCL 31 with respect to the high-stability resonator 33.

A feedback optical path from the reference QCL 31 through the beam splitters 53 and 54 to the high-stability resonator 33, and further through the photodetector 36 and the PDH circuit 34 back to the reference QCL 31, causes the laser light to be PDH-locked to the high-stability resonator 33 (the laser light is locked to the high-stability resonator 33 according to the PDH method). Inside the high-stability resonator 33, a pair of mirrors (not shown) is provided, similar to the CRDS resonator 40. However, the reflectivity of the mirrors disposed in the high-stability resonator 33 is lower than the reflectivity of the mirrors disposed in the CRDS resonator 40. If the reflectivity of the mirrors is too high, it becomes difficult to perform PDH locking. For this reason, mirrors having a reflectivity that allows for stable execution of PDH locking are employed in the high-stability resonator 33. Note that a gas absorption line with a narrow linewidth may be used instead of the high-stability resonator 33.

The PLL circuit 35 is capable of synchronizing the phase of the laser light of the measurement QCL 11 with the phase of the laser light of the reference QCL 31 by means of a phase-locked loop.

The PLL circuit 35 performs PLL control using a beat signal generated when the laser light output from the reference QCL 31 and the laser light output from the measurement QCL 11 interfere. As a result, the linewidth of the laser light output from the measurement QCL 11 is controlled to match the linewidth of the laser light (linewidth-narrowed) output from the reference QCL 31, which has had its linewidth narrowed.

Hereinafter, the details of the frequency stabilization circuit 30 will be described. The reference QCL 31 outputs laser light toward the high-stability resonator 33. Beam splitters 53 and 54 are disposed in the optical path between the reference QCL 31 and the high-stability resonator 33. The beam splitter 53 splits the laser light output from the reference QCL 31 into two and directs them to the beam splitter 52 and the beam splitter 54. The laser light traveling from the beam splitter 53 toward the beam splitter 54 is incident on the high-stability resonator 33.

The laser light output from the high-stability resonator 33 is returned to the beam splitter 54. The beam splitter 54 guides the laser light output from the high-stability resonator 33 to the photodetector 36. The photodetector 36 outputs a signal corresponding to the intensity of the laser light. The signal output from the photodetector 36 is input to the PDH circuit 34.

The PDH circuit 34 stabilizes the frequency of the laser light with respect to the high-stability resonator 33 according to the Pound-Drever-Hall (PDH) method. The PDH circuit 34 may, for example, include a generator, a phase shifter, a mixer, a low-pass filter, a servo circuit, and a laser driver, like a known circuit that operates according to the PDH method. The PDH circuit 34 stabilizes the frequency of the laser light by providing feedback to the reference QCL 31 based on the laser light detected by the photodetector 36.

Laser light from the measurement QCL 11 is input to the frequency stabilization circuit 30 via the beam splitter 51. The laser light incident on the frequency stabilization circuit 30 from the beam splitter 51 is guided to the beam splitter 52 by the mirror 61. Therefore, the laser light from the reference QCL 31 (frequency-stabilized) and the laser light from the measurement QCL are input to the beam splitter 52.

The beam splitter 52 outputs a combined laser light, which is a combination of the laser light from the reference QCL 31 (frequency-stabilized) and the laser light from the measurement QCL, to the photodetector 37. The photodetector 37 detects the beat of the combined light of the laser light from the measurement QCL 11 and the laser light from the reference QCL 31. The photodetector 37 outputs a detection signal to the PLL circuit 35.

The PLL circuit 35 synchronizes the phase of the laser light from the measurement QCL 11 with the phase of the laser light of the reference QCL 31 by means of a phase-locked loop. The beat frequency is stabilized by the phase-locked loop. A signal for stabilizing the beat frequency is fed back from the PLL circuit 35 to the measurement QCL 11.

The PLL circuit 35 superimposes the laser light output from the measurement QCL 11 and the laser light output from the reference QCL 31 to detect a beat signal. The PLL circuit 35 may sweep the frequency of the beat signal. This allows the wavelength of the laser light output from the measurement QCL 11 to be swept to a size corresponding to the spectrum measurement, while the linewidth of the laser light output from the measurement QCL 11 is narrowed.

For example, if the reference beat frequency (the target frequency to be stabilized) is set to 100 MHz, by stabilizing the laser light output from the measurement QCL 11 to match that 100 MHz, laser light with a wavelength shifted by 100 MHz from the reference QCL 31 can be output from the measurement QCL. In this way, the beat frequency can be controlled depending on the circuit design of the PLL circuit 35 that performs the PLL control.

As shown in FIG. 3, the frequency stabilization circuit 30 according to the present embodiment forms a feedback loop between the measurement QCL 11 and the AOM 20 for stabilizing the frequency of the laser light output from the measurement QCL 11. Instead of such a feedback loop, it is also conceivable to provide some kind of frequency stabilization circuit such that feedback is formed between the measurement QCL 11 and the AOM 20, and between the AOM 20 and the CRDS resonator 40.

However, in CRDS, it is necessary to block the incidence of light into the CRDS resonator 40 to acquire the ring-down signal. For this reason, if a frequency stabilization circuit is provided between the measurement QCL 11 and the AOM 20, the supply of laser light to the frequency stabilization circuit is interrupted while the incidence of light into the CRDS resonator is blocked. In this case, when the incidence of light into the CRDS resonator is resumed, the optimal wavelength of light for the CRDS resonator and the wavelength of the light incident on the CRDS resonator may be misaligned. As a result, a problem arises in that the gas absorption spectroscopy apparatus cannot achieve PDH lock after acquiring the ring-down signal.

Therefore, the present embodiment adopts a configuration that stabilizes the laser light output from the measurement QCL 11 without including the CRDS resonator 40 in the feedback optical system. That is, in the present embodiment, as shown in FIG. 3, a reference optical system (frequency stabilization circuit 30) including the reference QCL 31 and the high-stability resonator 33 is provided separately from the optical system of the measurement QCL 11, and PDH locking is performed in the reference optical system.

The frequency stabilization circuit 30 constituting the reference optical system performs PDH locking on the high-stability resonator 33 and stabilizes the linewidth of the laser light output from the reference QCL 31. The frequency stabilization circuit 30 further provides a feedback signal to the measurement QCL 11 using the beat signal between the laser light of the reference QCL 31 with the stabilized linewidth and the laser light of the measurement QCL 11.

For example, when a feedback signal for completely stabilizing the beat signal is given to the measurement QCL 11, laser light with the same linewidth as the reference QCL 31 is output from the measurement QCL 11. The frequency stabilization circuit 30 is an example of a frequency stabilization circuit disposed such that a negative feedback circuit is configured between the first light source and the optical modulator.

According to the present embodiment, the laser light of the measurement QCL 11 can be stabilized without including the CRDS resonator 40 in the feedback optical system for frequency stabilization. As a result, a signal for stabilizing the beat frequency can continue to be supplied from the frequency stabilization circuit 30 to the measurement QCL 11 even while the incidence of light into the CRDS resonator 40 is blocked.

Therefore, according to the present embodiment, it is possible to stabilize the frequency of the laser light even when the incidence of light into the CRDS resonator 40 is blocked to acquire a ring-down signal. According to the present embodiment, the oscillation frequency of the measurement QCL 11 can be narrowed without using the CRDS resonator 40. Therefore, an effect is also achieved in that the light source can be easily modularized. In general, since the linewidth of the laser light that resonates in a CRDS resonator is extremely narrow, it is technically difficult to perform PDH locking on a CRDS resonator. In the present embodiment, since it is not necessary to perform PDH locking on the CRDS resonator, the design of the gas absorption spectroscopy apparatus can be simplified.

In the present embodiment, the oscillation frequency of the measurement QCL 11 is narrowed by the frequency stabilization circuit 30. For this reason, the difficulty of performing PDH locking to the high-finesse CRDS resonator 40 can be reduced.

### Modification 1

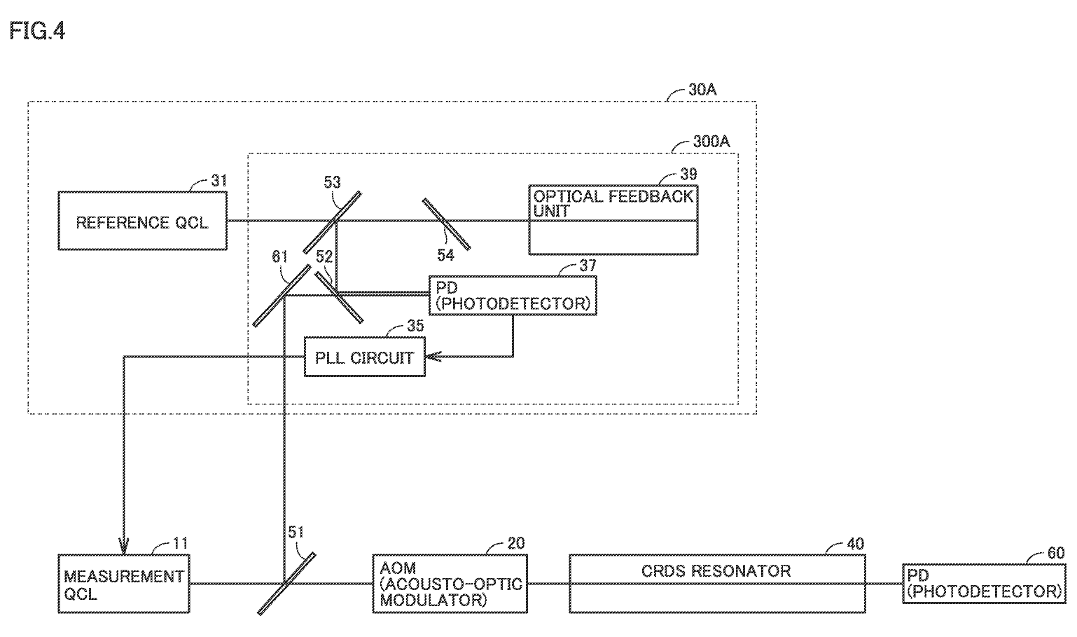

Next, Modification 1 will be described with reference to FIG. 4. FIG. 4 is a diagram schematically showing the configuration of a frequency stabilization circuit 30A according to Modification 1. In the frequency stabilization circuit 30A according to Modification 1, an optical feedback unit 39 is adopted instead of a circuit configuration that operates according to the Pound-Drever-Hall (PDH) method. The optical feedback unit 39 includes a gain layer and a passive layer. Light incident on the optical feedback unit 39 undergoes multiple resonances within the optical feedback unit 39. As a result, light with a stabilized wavelength is output from the optical feedback unit 39.

In Modification 1, the optical feedback unit 39, the PLL circuit 35, the photodetector 37, and the mirror 61 constitute a light stabilization unit 300A.

### Modification 2

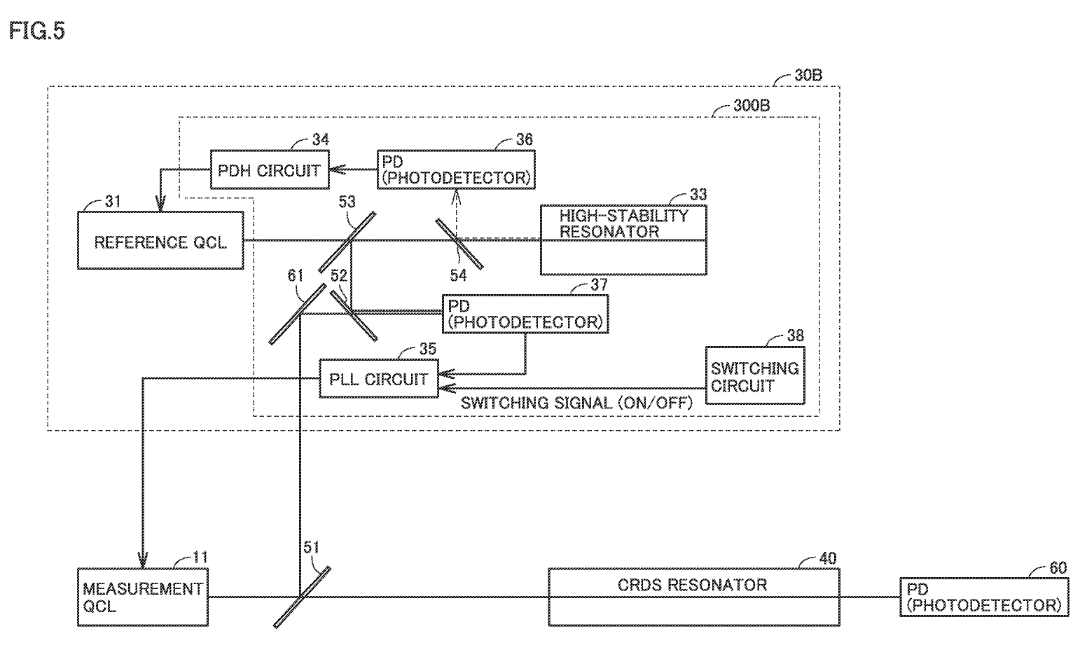

Next, Modification 2 will be described with reference to FIG. 5. FIG. 5 is a diagram schematically showing the configuration of a frequency stabilization circuit 30B according to Modification 2. In the description so far, the frequency stabilization circuits 30 and 30A having the AOM 20 have been exemplified. However, the frequency stabilization circuit does not necessarily have to have the AOM 20. FIG. 5 shows a frequency stabilization circuit 30B that does not have an AOM 20.

The frequency stabilization circuit 30B may switch the frequency to a non-resonant state by changing the current of the light source. By changing the current flowing through the light source, the oscillation frequency of the laser changes. This allows the CRDS resonator 40 to be switched between a resonant state and a non-resonant state. In this case, two methods are conceivable: a method of switching the locked target frequency while maintaining the PLL lock, and a method of unlocking the PLL only when performing a ring-down measurement to switch the frequency, and re-locking the PLL after the ring-down measurement is finished.

Both of these methods are methods of switching the frequency using the frequency stabilization circuit instead of an AOM. The light stabilization unit 300B shown in FIG. 5 has a switching circuit 38 for switching the frequency input to the PLL circuit 35 between ON and OFF. Therefore, the frequency stabilization circuit 30B has a function of switching the frequency, thereby switching the input of light to the CRDS resonator 40 and performing a ring-down measurement. The frequency stabilization circuit 30B shown in FIG. 5 is an example of a frequency stabilization circuit disposed such that a negative feedback circuit is configured between the first light source and the first resonator.

In Modification 2, the high-stability resonator 33, the PDH circuit 34, the PLL circuit 35, the photodetectors 36, 37, the beam splitters 52-54, the mirror 61, and the switching circuit 38 constitute a light stabilization unit 300B.

### Aspects

It is understood by those skilled in the art that the above-described embodiment and its modifications are specific examples of the following aspects.

(Aspect 1) A gas absorption spectroscopy apparatus for measuring a gas component, the apparatus comprising: a first light source that outputs first laser light used for measuring the gas component; a first resonator to which the first laser light is input; an optical modulator disposed in an optical path between the first light source and the first resonator; and a frequency stabilization circuit disposed so that a negative feedback circuit is configured between the first light source and the optical modulator, wherein the frequency stabilization circuit includes: a second light source that outputs second laser light for stabilizing the first laser light; and a light stabilization unit that stabilizes the second laser light.

In the gas absorption spectroscopy apparatus according to Aspect 1, the frequency of the laser light can be stabilized even when the incidence of light into the resonator is blocked to acquire a ring-down signal.

(Aspect 2) In the gas absorption spectroscopy apparatus according to Aspect 1, the light stabilization unit includes: a second resonator to which the second laser light is input; and a PDH (Pound-Drever-Hall) circuit for performing PDH lock with respect to the second resonator.

In the gas absorption spectroscopy apparatus according to Aspect 2, the second laser light can be stabilized by performing PDH (Pound-Drever-Hall) lock with respect to the second resonator.

(Aspect 3) In the gas absorption spectroscopy apparatus according to Aspect 1 or 2, the frequency stabilization circuit further includes a PLL (Phase Locked Loop) circuit that synchronizes a phase of the first laser light with a phase of the second laser light by a phase-locked loop.

In the gas absorption spectroscopy apparatus according to Aspect 3, the phase of the first laser light can be synchronized with the phase of the second laser light to stabilize the first laser light.

(Aspect 4) In the gas absorption spectroscopy apparatus according to Aspect 3, the PLL circuit is configured to superimpose the first laser light and the second laser light to detect a beat signal, and to sweep a frequency of the beat signal.

In the gas absorption spectroscopy apparatus according to Aspect 4, the frequency of the first laser light can be swept.

(Aspect 5) In the gas absorption spectroscopy apparatus according to any one of Aspects 1 to 4, the gas absorption spectroscopy apparatus further comprises a controller that measures the gas component using cavity ring-down spectroscopy.

In the gas absorption spectroscopy apparatus according to Aspect 5, the gas component can be measured by the controller.

(Aspect 6) In the gas absorption spectroscopy apparatus according to any one of Aspects 1 to 5, the optical modulator switches an input of light to the first resonator or a frequency of the first resonator.

In the gas absorption spectroscopy apparatus according to Aspect 6, the input of light to the first resonator or the frequency of the first resonator is switched by the optical modulator.

(Aspect 7) A gas absorption spectroscopy apparatus for measuring a gas component, the apparatus comprising: a first light source that outputs first laser light used for measuring the gas component; a first resonator to which the first laser light is input; and a frequency stabilization circuit disposed so that a negative feedback circuit is configured between the first light source and the first resonator, wherein the frequency stabilization circuit includes: a second light source that outputs second laser light for stabilizing the first laser light; and a light stabilization unit that stabilizes the second laser light.

In the gas absorption spectroscopy apparatus according to Aspect 7, the frequency of the laser light can be stabilized even when the incidence of light into the resonator is blocked to acquire a ring-down signal.

The embodiments disclosed this time should be considered illustrative in all respects and not restrictive. The scope of the present invention is indicated by the claims rather than by the description of the embodiments above, and is intended to include all modifications within the meaning and scope equivalent to the claims.

### DESCRIPTION OF REFERENCE NUMERALS

1 Gas absorption spectroscopy apparatus, 11 Measurement QCL, 20 AOM, 30, 30A, 30B Frequency stabilization circuit, 31 Reference QCL, 33 High-stability resonator, 34 PDH circuit, 35 PLL circuit, 36, 37, 60 Photodetector (PD), 39 Optical feedback unit, 40 CRDS resonator, 41, 42 Mirror, 43 Piezoelectric element, 44 Inlet pipe, 45 Outlet pipe, 46 Inlet valve, 47 Outlet valve, 51, 52, 53, 54 Beam splitter, 61 Mirror, 70 Controller, 71 Processor, 72 Memory, 300, 300A, 300B Light stabilization unit.

1. A gas absorption spectroscopy apparatus for measuring a gas component, the apparatus comprising:
a first light source that outputs first laser light used for the measurement of the gas component;
a first resonator to which the first laser light is input;
an optical modulator disposed in an optical path between the first light source and the first resonator; and
a frequency stabilization circuit disposed so that a negative feedback circuit is configured between the first light source and the optical modulator,
wherein the frequency stabilization circuit includes:
a second light source that outputs second laser light for stabilizing the first laser light; and
a light stabilization unit that stabilizes the second laser light.

2. The gas absorption spectroscopy apparatus according to claim 1, wherein the light stabilization unit includes:
a second resonator to which the second laser light is input; and
a PDH (Pound-Drever-Hall) circuit for performing a PDH lock with respect to the second resonator.

3. The gas absorption spectroscopy apparatus according to claim 1, wherein the frequency stabilization circuit further includes a PLL (Phase Locked Loop) circuit that synchronizes a phase of the first laser light with a phase of the second laser light by a phase-locked loop.

4. The gas absorption spectroscopy apparatus according to claim 3, wherein the PLL circuit is configured to superimpose the first laser light and the second laser light to detect a beat signal, and to sweep a frequency of the beat signal.

5. The gas absorption spectroscopy apparatus according to claim 1, further comprising a controller that measures the gas component using cavity ring-down spectroscopy.

6. The gas absorption spectroscopy apparatus according to claim 1, wherein the optical modulator switches an input of light to the first resonator or a frequency of the first resonator.

7. A gas absorption spectroscopy apparatus for measuring a gas component, the apparatus comprising:
a first light source that outputs first laser light used for the measurement of the gas component;
a first resonator to which the first laser light is input; and
a frequency stabilization circuit disposed so that a negative feedback circuit is configured between the first light source and the first resonator, wherein the frequency stabilization circuit includes:
a second light source that outputs second laser light for stabilizing the first laser light; and
a light stabilization unit that stabilizes the second laser light.
